(19) United States
(12) Patent Application Publication
(10) Pub. No.: US 2025/0173854 A1
(43) Pub. Date: May 29, 2025

(54) Voice Coil Winding Real-Time Quality Control Method, System, And Corresponding Apparatus

(71) Applicant: AAC Microtech (Changzhou) Co., Ltd., Changzhou City (CN)

(72) Inventors: Zhichen Chen, Changzhou (CN); Liang Chen, Changzhou (CN); Xuelei Cai, Changzhou (CN); Qicong Zhu, Changzhou (CN); Yuemei Gu, Changzhou (CN); Qunfeng Jiang, Changzhou (CN); Chuang Du, Changzhou (CN); Chun Wang, Changzhou (CN); Yuan Gu, Changzhou (CN)

(21) Appl. No.: 18/796,229

(22) Filed: Aug. 6, 2024

Related U.S. Application Data
(63) Continuation of application No. PCT/CN2023/134401, filed on Nov. 27, 2023.

(51) Int. Cl. G06T 7/00

(52) U.S. Cl. CPC G06T 7/0006; G06T 2207/20081; G06T 2207/30108

(57) ABSTRACT

Disclosed is a manufacturing process optimization method, and more particularly relates to a voice coil winding real-time quality control method, system, and a corresponding apparatus. In the method as disclosed, the influence model is built via data analysis to calibrate relevancy between product quality and production line-related performance input parameter, which allows for directing a commissioning technician to perform remote, targeted parameter adjustment, without constant trial and error on the production line or shutting down the production line for adjustment like in conventional technologies; the method disclosed herein enhances production line throughput stability and can effectively improve the yield rate and work efficiency of the voice coil production line.

### FIELD

The present disclosure relates to a manufacturing process optimization method, and more particularly relates to a voice coil winding real-time quality control method, system, and a corresponding apparatus.

### BACKGROUND

A voice coil is an important component of a sound-producing device such as a loudspeaker. In industrial manufacturing, the voice coil is formed by winding a blank using a manufacturing machine comprising a cylinder and a wire bending structure.

Voice coil winding and real-time quality control are conventionally done manually by technicians. For a workshop with 4 production lines, 5 commissioning technicians need to be deployed simultaneously on site to perform quality image comparison, process monitoring, and parameter adjustment in case of quality change in the winding process.

However, conventional real-time voice-coil quality control processes have two major problems:

Firstly, the commissioning technicians perform commissioning based on on-site data acquired by an inspection device and a video captured by a high-definition camera. Since no quantitative data are available for machine cylinder commissioning and rotary knob tightness adjustment, the manufacturing process relies heavily on the front-line operators' experience developed from trial-and-error, which is technically uncontrollable; in addition, the production line throughput is likely affected due to absence of critical personnel;

Secondly, the items to commission include equipment PLC (Programmable Logic Controller) parameters, cylinder pressure, and tightness of a wire bending rotary knob on the machine; however, due to uncontrollable fluctuation of blank quality, the commissioning technicians need to always stand by to inspect quality conditions; this manual inspection practice is not only inefficient, but also unable to ensure a stable yield rate.

Therefore, it is desirable to provide a novel method for real-time quality control of voice coil winding which overcomes the above drawbacks.

### SUMMARY

Embodiments of the disclosure provide a voice coil winding real-time quality control method, system, and a corresponding apparatus to reduce trial-and-error overheads and facilitate operation.

To address the drawbacks in conventional technologies, in a first aspect of the disclosure, there is provided a voice coil winding real-time quality control method, comprising:
S101: building a qualitative influence model defining relevancy between a parameter input factor and a quality inspection result in a voice coil winding process;
S102: inspecting, in real-time, a voice coil manufactured in the voice coil winding process via machine vision inspection according to a preset defective-product detection rule, and acquiring a defective-voice-coil image of a corresponding voice coil which meets the preset defective-product detection rule;
S103: obtaining, via a self-taught machine learning unit, a quality inspection result from the defective-voice-coil image;
S104: adjusting a corresponding parameter input factor based on the qualitative influence model and the quality inspection result;
S105: inspecting, in real time, via machine vision inspection, a voice coil formed according to a parameter input factor-adjusted voice coil winding process, and outputting a parameter-adjusted result in a case that the voice coil meets a preset non-defective product detection rule;
S106: feeding back the parameter-adjusted result to the self-taught machine learning unit, so that manufacturing rolls back from S102 to continue the parameter input factor-adjusted voice coil winding process.

In some implementations, the preset defective-product detection rule referred to in step S102 is set as detection of a voice coil not conforming with requirements of the voice coil winding process for consecutively N times, where N is a positive integer.

In some implementations, the preset defective-product detection rule referred to in step S102 may be set as such: computed yield rate of first A number of voice coils currently manufactured decreases for consecutively B times, where A and B are positive integers.

In some implementations, the preset non-defective product detection rule referred to in step S105 is set as detection of a voice coil conforming with requirements of the voice coil winding process for consecutive M times, where M is a positive integer.

In some implementations, in step S104, the corresponding parameter input factor is adjusted remotely.

In some implementations, in step S102, the machine vision inspection is CCD (charge coupled device) inspection.

In some implementations, in step S105, the machine vision inspection is a dual-inspection scheme including CCD inspection and AOI (Auto Optical Inspection).

In a second aspect of the disclosure, there is further provided a voice coil winding real-time quality control system, comprising:
an influence model building module configured to build a qualitative influence model defining relevancy between a parameter input factor and a quality inspection result in a voice coil winding process;
a production inspecting module configured to inspect, in real-time, a voice coil manufactured in the voice coil winding process via machine vision inspection according to a preset defective-product detection rule, and acquire a defective-voice-coil image of a corresponding voice coil which meets the preset defective-product detection rule;
a quality inspecting module configured to obtain, via a self-taught machine learning module, a quality inspection result from the defective-voice-coil image;
a parameter adjusting module configured to adjust a corresponding parameter input factor based on the qualitative influence model and the quality inspection result;
an adjustment inspecting module configured to inspect, in real time, via machine vision inspection, a voice coil formed according to a parameter input factor-adjusted voice coil winding process, and output a parameter-adjusted result in a case that the voice coil meets a preset non-defective product detection rule; and
a quality feedback module configured to feed back the parameter-adjusted result to the self-taught machine learning unit, so that manufacturing rolls back from the production inspecting module to continue the parameter input factor-adjusted voice coil winding process.

In a third aspect of the disclosure, there is further provided a computer device, comprising: a memory, a processor, and a voice coil winding real-time quality control program stored on the memory and executable by the processor, the processor, when executing the voice coil winding real-time quality control program, performs the voice coil winding real-time quality control method as stated above.

In a fourth aspect of the disclosure, there is provided a computer-readable storage medium, wherein a voice coil winding real-time quality control program is stored on the computer-readable storage medium, the voice coil winding real-time quality control program, when being executed by a processor, performs the voice coil winding real-time quality control method as stated above.

Compared with conventional technologies, the voice coil winding real-time quality control method according to the disclosure comprises the following steps:

S101: building a qualitative influence model defining relevancy between a parameter input factor and a quality inspection result in a voice coil winding process; S102: inspecting, in real-time, a voice coil manufactured in the voice coil winding process via machine vision inspection according to a preset defective-product detection rule, and acquiring a defective-voice-coil image of a corresponding voice coil which meets the preset defective-product detection rule; S103: obtaining, via a self-taught machine learning unit, a quality inspection result from the defective-voice-coil image; S104: adjusting a corresponding parameter input factor based on the qualitative influence model and the quality inspection result; S105: inspecting, in real time, via machine vision inspection, a voice coil formed according to a parameter input factor-adjusted voice coil winding process, and outputting a parameter-adjusted result in a case that the voice coil meets a preset non-defective product detection rule; S106: feeding back the parameter-adjusted result to the self-taught machine learning unit, so that manufacturing rolls back from S102 to continue the parameter input factor-adjusted voice coil winding process. In this method, the influence model is built via data analysis to calibrate relevancy between product quality and production line-related performance input parameter, which allows for directing a commissioning technician to perform remote, targeted parameter adjustment, without constant trial and error on the production line or shutting down the production line for adjustment like in conventional technologies; the method disclosed herein enhances production line throughput stability and can effectively improve the yield rate and work efficiency of the voice coil production line.

### BRIEF DESCRIPTION OF THE DRAWINGS

To illustrate the technical solutions in the embodiments of the disclosure more clearly, the drawings referred to in describing the embodiments will be introduced briefly. It is apparent that the drawings provided below are only some embodiments of the disclosure, and to those skilled in the art, other drawings may also be derived based on these drawings without exercise of inventive work, in which:

FIG. 1 is a flow diagram of steps of a voice coil winding real-time quality control method according to the disclosure;

FIG. 2 is a structural schematic diagram of a voice coil winding real-time quality control system according to an implementation of the disclosure;

FIG. 3 is a structural schematic diagram of a computer device according to an implementation of the disclosure.

### DETAILED DESCRIPTION OF EMBODIMENTS

Hereinafter, the technical solutions in the embodiments of the disclosure will be given a clear and comprehensive description with reference to the accompanying drawings referred to in the embodiments of the disclosure; apparently, the embodiments described herein are only some embodiments of the disclosure, not all of them. All other embodiments derived by a person of normal skill in the art from those described herein without exercise of inventive work will fall into the protection scope of the disclosure.

### First Embodiment

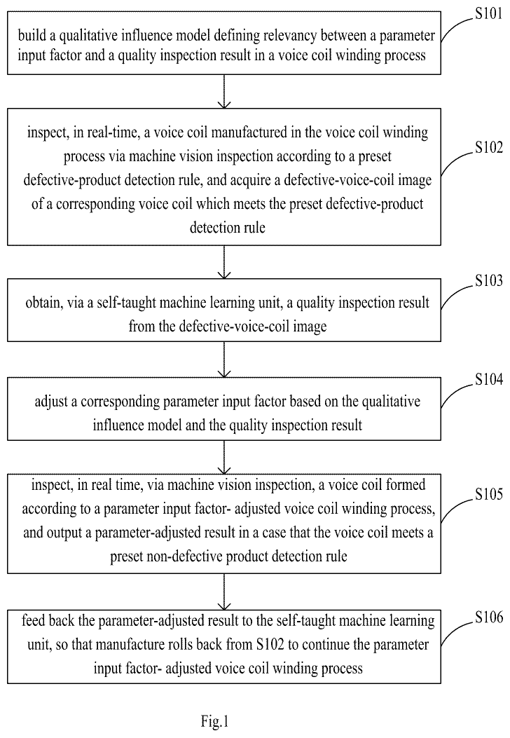

Referring to FIG. 1, which illustrates a flow diagram of a voice coil winding real-time quality control method according to the disclosure, the voice coil winding real-time quality control method comprises the following steps:

In step S101, a qualitative influence model defining relevancy between a parameter input factor and a quality inspection result in a voice coil winding process is built.

Specifically, the voice coil winding process referred to in the embodiments of the disclosure is a process in which an operator such as a commissioning technician adjusts a production line parameter in an actual manufacturing process to control a manufacturing machine such as a winding machine to form voice coil winding; the qualitative influence model serves to calibrate relevancy between a parameter input factor and a quality inspection result, where the parameter input factor is a manufacturing machine parameter pre-inputted by the commissioning technician, and the quality inspection result refers to quality data of a voice coil formed by the manufacturing machine.

In step S102, a voice coil manufactured in the voice coil winding process is inspected in real time via machine vision inspection according to a preset defective-product detection rule, and a defective-voice-coil image of a corresponding voice coil which satisfies the defective-product detection rule is acquired.

The machine vision inspection referred to in step S102 is CCD (charge coupled device) inspection. In the embodiments of the disclosure, non-defective product detection criteria are set according to existing criteria for voice coil winding processes, so that voice coils not conforming with the non-defective product detection criteria can be identified via the real-time machine vision inspection in step S102 and images of to-be-confirmed defective products are acquired according to the preset defective-product detection rule.

The preset defective-product detection rule referred to in step S102 is set as detection of a voice coil not conforming with requirements of the voice coil winding process for consecutively N times, where N is a positive integer.

In another alternative embodiment, the preset defective-product detection rule referred to in step S102 may be set as such: computed yield rate of first A number of voice coils currently manufactured decreases for consecutively B times, where A and B are positive integers. As desired, the preset defective-product detection rule may be set based on actual throughput and efficiency of the voice coil winding process.

In step S103, a quality inspection result from the defective-voice-coil image is obtained via a self-taught machine learning unit.

The self-taught machine learning unit referred to in the embodiments of the disclosure is an industrial big data analysis-based computing unit. Specifically, the self-taught machine learning unit is operable to identify a specific defect in the defective-voice-coil image according to the qualitative influence model and produce a quality inspection result; since the quality inspection result and the parameter input factor are correlated in the qualitative influence model, the self-taught machine learning unit identifies a specific defect-producing parameter input factor actually from the defective-voice-coil image.

In step S104, a corresponding parameter input factor is adjusted based on the qualitative influence model and the quality inspection result.

This step may be implemented in various ways based on actual deployment of the voice coil winding real-time quality control method as described herein. In step S104, the corresponding parameter input factor is adjusted remotely. This implementation is applicable to a scenario where a control console for parameter input is deployed external to the production line; in this scenario, the adjusted parameter input factor is inputted to the manufacturing machine such as the winding machine via remote parameter control, thereby allowing for real-time adjustment of voice coil winding.

In step S105, a voice coil formed according to a parameter input factor-adjusted voice coil winding process is inspected in real time via machine vision inspection according to a preset non-defective product detection rule, and a parameter-adjusted result is outputted in a case that the voice coil meets the preset non-defective product detection rule.

The preset non-defective product detection rule referred to in step S105 is set as detection of a voice coil conforming with requirements of the voice coil winding process for consecutive M times, where M is a positive integer.

The machine vision inspection referred to in step S105 is a dual-inspection scheme including CCD inspection and AOI (Auto Optical Inspection). The dual-inspection scheme can give a more specific analysis of whether the voice coil manufactured with the adjusted parameter input factor can meet the non-defective product criteria, thereby preventing occurrence of invalid adjustment. The parameter-adjusted result specifically serves to increase the relevancy between the parameter input factor and the quality inspection result in the qualitative influence model, so that the adjusted production line condition can be reflected in the qualitative influence model.

In step S106, the parameter-adjusted result is fed back to the self-taught machine learning unit, so that manufacturing rolls back from step S102 according to the parameter input factor-adjusted voice coil winding process.

Specifically, the adjustment performed based on the parameter input factor in the embodiments of the disclosure is only applied upon occurrence of defective products or drop of yield rate; manufacturing of the voice coil winding process continues according to a normal flow of the production line upon completion of the adjustment, in which case the manufacturing machine such as the winding machine operates seamlessly based on the adjusted parameter, whereby the yield rate increases. In the embodiments of the disclosure, after the parameter-adjusted result is fed back to the self-taught machine learning unit, defect detection accuracy of the self-taught machine learning unit can be enhanced, whereby work efficiency of the commissioning technician is improved.

Compared with conventional technologies, the voice coil winding real-time quality control method according to the disclosure comprises the following steps:

S101: building a qualitative influence model defining relevancy between a parameter input factor and a quality inspection result in a voice coil winding process; S102: inspecting, in real-time, a voice coil manufactured in the voice coil winding process via machine vision inspection according to a preset defective-product detection rule, and acquiring a defective-voice-coil image of a corresponding voice coil which meets the preset defective-product detection rule; S103: obtaining, via a self-taught machine learning unit, a quality inspection result from the defective-voice-coil image; S104: adjusting a corresponding parameter input factor based on the qualitative influence model and the quality inspection result; S105: inspecting, in real time, via machine vision inspection, a voice coil formed according to a parameter input factor-adjusted voice coil winding process, and outputting a parameter-adjusted result in a case that the voice coil meets a preset non-defective product detection rule; S106: feeding back the parameter-adjusted result to the self-taught machine learning unit, so that manufacturing rolls back from S102 to continue the parameter input factor-adjusted voice coil winding process. In this method, the influence model is built via data analysis to calibrate relevancy between product quality and production line-related performance input parameter, which allows for directing a commissioning technician to perform remote, targeted parameter adjustment, without constant trial and error on the production line or shutting down the production line for adjustment like in conventional technologies; the method disclosed herein enhances production line throughput stability and can effectively improve the yield rate and work efficiency of the voice coil production line.

### Second Embodiment

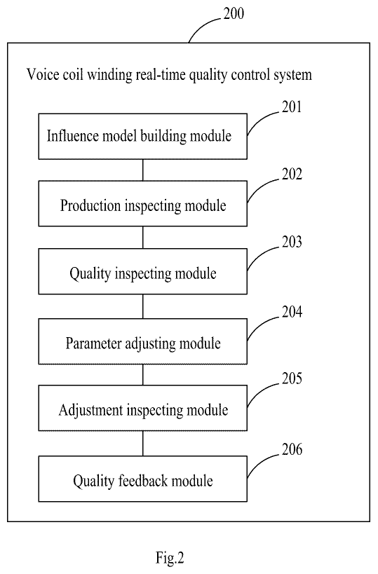

Embodiments of the disclosure further provide a voice coil winding real-time quality control system. Referring to FIG. 2, which illustrates a structural schematic diagram of a voice coil winding real-time quality control system according to an implementation of the disclosure, the voice coil winding real-time quality control system 200 comprises:
an influence model building module 201 configured to build a qualitative influence model defining relevancy between a parameter input factor and a quality inspection result in a voice coil winding process;
a production inspecting module 202 configured to inspect, in real-time, a voice coil manufactured in the voice coil winding process via machine vision inspection according to a preset defective-product detection rule, and acquire a defective-voice-coil image of a corresponding voice coil which meets the preset defective-product detection rule;
a quality inspecting module 203 configured to obtain, via a self-taught machine learning unit, a quality inspection result from the defective-voice-coil image;
a parameter adjusting module 204 configured to adjust a corresponding parameter input factor based on the qualitative influence model and the quality inspection result;
an adjustment inspecting module 205 configured to inspect, in real time, via machine vision inspection, a voice coil formed according to a parameter input factor-adjusted voice coil winding process, and output a parameter-adjusted result in a case that the voice coil meets a preset non-defective product detection rule; and
a quality feedback module 206 configured to feed back the parameter-adjusted result

to the self-taught machine learning unit, so that manufacturing rolls back from the production inspecting module 202 to continue the parameter input factor-adjusted voice coil winding process.

The voice coil winding real-time quality control system 200 can implement the steps in the voice coil winding real-time quality control method in the embodiment described supra and can achieve the same technical effects, which may refer to the embodiment described above and are thus not detailed here.

### Third Embodiment

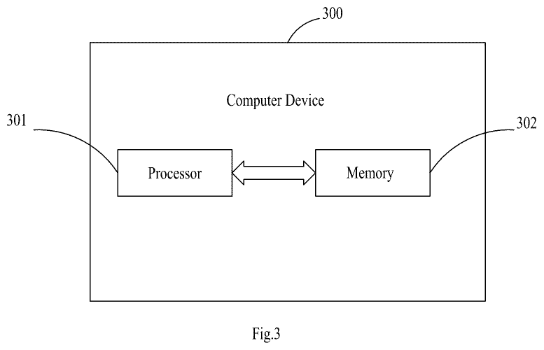

Embodiments of the disclosure further provide a computer device. Referring to FIG. 3, which illustrates a structural schematic diagram of a computer device according to some embodiments of the disclosure, the computer device 300 comprises: a memory 302, a processor 301, and a computer program stored on the memory 302 and executable by the processor 301.

The processor 301 invokes the computer program stored in the memory 302 to execute the steps in the voice coil winding real-time quality control method provided in the embodiments of the disclosure, which, referring to FIG. 1, specifically comprise steps below:
S101: building a qualitative influence model defining relevancy between a parameter input factor and a quality inspection result in a voice coil winding process;
S102: inspecting, in real-time, a voice coil manufactured in the voice coil winding process via machine vision inspection according to a preset defective-product detection rule, and acquiring a defective-voice-coil image of a corresponding voice coil which meets the preset defective-product detection rule;
the preset defective-product detection rule in step S102 is set as detection of a voice coil not conforming with requirements of the voice coil winding process for consecutively N times, where N is a positive integer;
the preset defective-product detection rule referred to in step S102 may be set as such: computed yield rate of first A number of voice coils currently manufactured decreases for consecutively B times, where A and B are positive integers;
the machine vision inspection referred to in step S102 is CCD (charge coupled device) inspection;
S103: obtaining, via a self-taught machine learning unit, a quality inspection result from the defective-voice-coil image;
S104: adjusting a corresponding parameter input factor based on the qualitative influence model and the quality inspection result;
in step S104, the corresponding parameter input factor is adjusted remotely;
S105: inspecting, in real time, via machine vision inspection, a voice coil formed according to a parameter input factor-adjusted voice coil winding process, and outputting a parameter-adjusted result in a case that the voice coil meets a preset non-defective product detection rule;
the preset non-defective product detection rule referred to in step S105 is set as
detection of a voice coil conforming with requirements of the voice coil winding process for consecutive M times, where M is a positive integer;
the machine vision inspection referred to in step S105 is a dual-inspection scheme including CCD inspection and AOI (Auto Optical Inspection).
S106: feeding back the parameter-adjusted result to the self-taught machine learning unit, so that manufacturing rolls back from step S102 according to the parameter input factor-adjusted voice coil winding process.

The computer device 300 provided according to the embodiments of the disclosure can implement the steps in the voice coil winding real-time quality control method in the embodiment described supra and can achieve the same technical effects, which may refer to the embodiment described above and are thus not detailed here.

### Fourth Embodiment

Embodiments of the disclosure further provide a computer-readable storage medium, a computer program being stored on the computer-readable storage medium; the computer program, when being executed by a processor, performs respective procedures and steps in the voice coil winding real-time quality control method provided according to the embodiments of the disclosure and can achieve the same technical effect, which, for the sake of brevity, are not detailed here.

A person of normal skill in the art may understand that, all or part of the flow in the method described in the embodiments above may be implemented by a computer program instructing corresponding hardware; the program may be stored in a computer-readable storage medium; when being executed, the program may include a flow as described in the method embodiments. The storage medium may be specifically a magnetic disc, an optical disc, a ROM (Read-Only Memory) or a RAM (Random Access Memory), etc.

It is noted that, the term “include,” “comprise,” or any other variable thereof intends to an non-exclusive inclusion, so that a process, a method, an item, or an apparatus including a series of elements not only includes these elements, but also include those elements not explicitly set forth, or further include the elements inherent in the process, method, item, or apparatus. Without more limitations, an element limited by the phrase “comprising a . . . ” does not exclude further presence of other same elements in the process, method, item, or apparatus including the element.

Through the above description of the embodiments, those skilled in the art may clearly understand that the method described above may be implemented by software plus a necessary general hardware platform, which, of course, may also be implemented by hardware; but in many circumstances, the former is a preferred implementation mode. Based on such understanding, the substantive technical solution of the disclosure or the part of the disclosure contributing to conventional technologies may be embodied as a software product; the computer software product is stored in a storage medium (e.g., ROM/RAM, magnetic disc, optical disc) and includes a plurality of instructions so that one terminal (which may be a mobile phone, a computer, a server, an air-conditioner, or a network device) executes the method described in various embodiments of the disclosure.

The embodiments of the disclosure have been described with reference to the accompanying drawings; what have been disclosed are only preferred embodiments of the disclosure; however, the disclosure is not limited to the example implementations described above. The example implementations are only schematic, not limitative. Under the teaching of the disclosure, a person of normal skill in the art may make various equivalent changes without departing from the principle of the disclosure or the extent of scope as defined in the claims, and all such equivalent changes fall within the scope of protection of the disclosure.

I/we claim:

1. A voice coil winding real-time quality control method, comprising:
S101: building a qualitative influence model defining relevancy between a parameter input factor and a quality inspection result in a voice coil winding process;
S102: inspecting, in real-time, a voice coil manufactured in the voice coil winding process via machine vision inspection according to a preset defective-product detection rule, and acquiring a defective-voice-coil image of a corresponding voice coil which meets the preset defective-product detection rule;
S103: obtaining, via a self-taught machine learning unit, a quality inspection result from the defective-voice-coil image;
S104: adjusting a corresponding parameter input factor based on the qualitative influence model and the quality inspection result;
S105: inspecting, in real time, via machine vision inspection, a voice coil formed according to a parameter input factor-adjusted voice coil winding process, and outputting a parameter-adjusted result in a case that the voice coil meets a preset non-defective product detection rule;
S106: feeding back the parameter-adjusted result to the self-taught machine learning unit, so that manufacturing rolls back from S102 to continue the parameter input factor-adjusted voice coil winding process.

2. The voice coil winding real-time quality control method according to claim 1, wherein the preset defective-product detection rule referred to in step S102 is set as detection of a voice coil not conforming with requirements of the voice coil winding process for consecutively N times, where N is a positive integer.

3. The voice coil winding real-time quality control method according to claim 1, wherein the preset defective-product detection rule referred to in step S102 may be set as such: computed yield rate of first A number of voice coils currently manufactured decreases for consecutively B times, where A and B are positive integers.

4. The voice coil winding real-time quality control method according to claim 1, wherein the preset non-defective product detection rule referred to in step S105 is set as detection of a voice coil conforming with requirements of the voice coil winding process for consecutive M times, where M is a positive integer.

5. The voice coil winding real-time quality control method according to claim 1, wherein in step S104, the corresponding parameter input factor is adjusted remotely.

6. The voice coil winding real-time quality control method according to claim 1, wherein in step S102, the machine vision inspection is CCD (charge coupled device) inspection.

7. The voice coil winding real-time quality control method according to claim 1, wherein in step S105, the machine vision inspection is a dual-inspection scheme including CCD (charge coupled device) inspection and AOI (Auto Optical Inspection).

8. A voice coil winding real-time quality control system, comprising:
an influence model building module configured to build a qualitative influence model defining relevancy between a parameter input factor and a quality inspection result in a voice coil winding process;
a production inspecting module configured to inspect, in real-time, a voice coil manufactured in the voice coil winding process via machine vision inspection according to a preset defective-product detection rule, and acquire a defective-voice-coil image of a corresponding voice coil which meets the preset defective-product detection rule;
a quality inspecting module configured to obtain, via a self-taught machine learning module, a quality inspection result from the defective-voice-coil image;
a parameter adjusting module configured to adjust a corresponding parameter input factor based on the qualitative influence model and the quality inspection result;
an adjustment inspecting module configured to inspect, in real time, via machine vision inspection, a voice coil formed according to a parameter input factor-adjusted voice coil winding process, and output a parameter-adjusted result in a case that the voice coil meets a preset non-defective product detection rule; and
a quality feedback module configured to feed back the parameter-adjusted result to the self-taught machine learning unit, so that manufacturing rolls back from the production inspecting module to continue the parameter input factor-adjusted voice coil winding process.

9. A computer device, comprising: a memory, a processor, and a voice coil winding real-time quality control program stored on the memory and executable by the processor, the processor, when executing the voice coil winding real-time quality control program, performs the voice coil winding real-time quality control method according to any one of claims 1-7.

10. A computer-readable storage medium, wherein a voice coil winding real-time quality control program is stored on the computer-readable storage medium, the voice coil winding real-time quality control program, when being executed by a processor, performs the voice coil winding real-time quality control method according to any one of claims 1-7.
